(19) United States
(12) Patent Application Publication
(10) Pub. No.: US 2012/0164290 A1
(43) Pub. Date: Jun. 28, 2012

(54) NOVEL ALCOHOLIC AERATED PRODUCT

(75) Inventor: Antonius Johannes Maria Gerrits, Elsendorp (NL)

(73) Assignee: FrieslandCampina Nederland Holding B.V., Zaltbommel (NL)

(21) Appl. No.: 13/380,737

(22) PCT Filed: Jun. 24, 2010
(86) PCT No.: PCT/NL10/50392

§ 371 Date: Mar. 15, 2012

(30) Foreign Application Priority Data
Jun. 26, 2009 (EP) 09163876.7

(51) Int. Cl. C12G 3/06; A23L 1/0562

(52) U.S. Cl. 426/329; 426/564; 426/474; 426/592

(57) ABSTRACT

The present invention is directed to a novel aerated product having an alcohol content of above 5% (v/v). Said product is particularly suitable for preparing alcoholic hot beverages comprising a cream-like component. The product is stable for several months at refrigerator or at room temperature. Also provided is a method for preparing such alcoholic aerated product.

### FIELD OF THE INVENTION

The present invention is concerned with an alcoholic aerated (foam) composition that may advantageously be used to prepare hot alcoholic beverages with a frothy layer such as Irish Coffee. Further, a method for the preparation of such foam composition is provided.

### BACKGROUND

Alcoholic hot beverages such as Irish Coffee are generally prepared by mixing coffee, sugar, and alcohol such as Irish whiskey, in a glass, followed by the addition of whipped cream. The whipped cream rests afloat of the hot coffee, and slowly dissolves into the coffee.

Whipped cream is prepared by beating air bubbles into cream. Alternatively, instant whipping cream or ready-made whipped cream may be employed. In traditional preparation of Irish Coffee, about 120 g hot coffee, 12 g (brown) sugar, and 30 ml whisky are mixed. This is topped with about 30 g of whipped cream.

For convenience purposes, it would be desirable to prepare a ready-to-go composition that may be combined with coffee only to prepare such alcoholic hot beverage. It is important for such composition that it is stable at a temperature of 4-10° C. for a prolonged time period such as at least 8 weeks to enable the distribution and sales trajectory. Whipping cream in general comprises about 20-50% (w/w) fat. By whipping, large air bubbles are beaten into the cream which are subsequently broken up into smaller ones. Milk proteins adsorb onto the air-water interface to stabilise the initial airy structure. In a later stage of the whipping process, fat globules attach to the air-water interface. Fat globules collide, and partial coalescence of fat globules occurs and some liquid fat from the fat globules spreads over the air-water interface. The whipping is to lead to a specific structure, in which the air comprises 40-60% of the volume, the air bubbles are relatively small, the bubbles are fully covered by fat globules and fat globule clumps, and the clumped fat globules make a space-filling network throughout the plasma phase. This network also makes contact with the bubbles. In this way, a firm, smooth and relatively stable product results.

The addition of alcohol to whipping cream is detrimental to the formation of a smooth and relatively stable whipped cream, in particular when large amounts of alcohol are added. It is hypothesized that the alcohol interferes with the formation of a protein layer around the air bubbles, and/or might affect the oil-spreading. As such, only few alcoholic whipping or whipped cream products are on the market. All these have a low alcohol content to prevent destabilization to the extent possible.

One product with a foamy character containing alcohol that is commercially available is red wine mousse (Mousse Rotwein) of Dr. Oetker, which is available on the German market. However, this product comprises only about 3 vol. % alcohol.

Hitherto, no stable products with a foamy character having a high alcohol content (above 5 vol. % alcohol) are known.

### SUMMARY OF THE INVENTION

It is an object of the present invention to provide an alcoholic whipped cream-type aerated composition that provides convenience to a consumer, e.g. in the preparation of hot alcoholic beverages with a frothy layer such as Irish Coffee, Brazilian Coffee, Spanish Coffee, and the like. Said aerated composition comprises all ingredients of said hot alcoholic beverages, excluding the hot beverage itself, e.g. coffee, hot chocolate, or tea. Said aerated composition comprises about 5-25 vol % alcohol, about 8-18% (w/w) fat, about 0.5-5% (w/w) protein, said protein comprising gelatin, and water.

In a further aspect, the invention is directed to a single-serve package comprising said aerated composition.

Also, the invention provides for the use of such aerated composition for the preparation of an alcoholic hot beverage.

### DETAILED DESCRIPTION OF THE INVENTION

The present invention relates to a novel aerated composition comprising about 5-25 vol % alcohol, about 8-18% (w/w) fat, about 0.5-5% (w/w) protein, said protein comprising gelatin, and water. An aerated composition according to the present invention also has good foam properties, such as good overrun and a good stability. As used herein, the term “aerated” means that gas has been intentionally incorporated into the composition, for example by mechanical means such as whipping. It may also be referred to as “foam composition”. The extent of aeration is defined in terms of “overrun” or may be indicated using “vol. % gas”. Overrun is a figure indicating the increase in volume caused by the whipping: An overrun of 200% means an original liquid volume of 1 litre is increased to 3 litres of foam. In the context of the present invention, % overrun is defined in volume terms as: % overrun=((volume of aerated product−volume of liquid prior to aeration)/volume of liquid prior to aeration)×100%. According to the present invention, a composition is aerated if it has an overrun of at least about 10%, preferably at least about 15%, such as at least about 20%, 25%, 30%, 35%, 40%, 45%, 50%, 60%, or more. It is expected that the composition will have an overrun of at most about 200%, 150%, 125%, or 100%.

Stability can be defined as the change in total behaviour of the product after a given storage time and temperature compared to the behaviour when freshly prepared.

This total behaviour is a combination of items like foam volume, the size and distribution of the gas bubbles, the colour and taste of the foam. Most important is the behaviour when “spooned” onto the hot beverage: the ease of the addition, the visual look of the total hot beverage, the way the foam melts and slowly disperses into the hot beverage and the taste of the total hot beverage.

Preferably, said aerated composition is stable for at least 8 weeks, more preferably at least 12 weeks, at a temperature of 0-10° C. In an embodiment, said composition is stable for at least 8 weeks, preferably at least 12 weeks, at room temperature (18-22° C.).

The volume stability is determined by measuring the height of the foam. It is given in percentages, which means that 100% means the height has not changed and for examples 50% means that the height of the foam is half as it was at the start of the measurement. “Volume stability” is defined in the context of the present invention as the percentage of the overrun that remains at time T after aeration of the product at time T=0: % Stability=(Overrun (T)/Overrun (0))×100%. A composition is found to be stable when the % volume stability is at least 70%, such as 75%, 80%, 85%, 90%, 95%, or more. Preferably, said aerated composition is volume stable for at least 8 weeks, more preferably at least 12 weeks, even more preferably at least 18 weeks, and most preferably at least 26 weeks, at a temperature of 0-10° C. In an embodiment, said composition is volume stable for at least 8 weeks, preferably at least 12 weeks, even more preferably at least 18 weeks, and most preferably at least 26 weeks, at room temperature (18-22° C.).

The colour stability can be measured with well known colour measurement equipment giving values like LAB etc. Depending on the original colour a change after the storage time is easily measured and should not be more than 10% change in measured values.

Important is the size and distribution of the gas bubbles. Instability of foams is often caused by disproportionation of the gas bubbles, in which process the smaller bubbles shrink in volume and the bigger ones grow in volume as a result of gas diffusion. Larger gas bubbles give when added onto the hot beverage a less nice, coarser foam layer and the danger of too quick melting of the foam, causing an insufficient foam amount on the surface of the hot beverage.

Measuring the size and distribution of gas bubbles is not easy since the method itself often influences the size. Filling a transparent container and making images in time gives an impression of the stability. Using a panel of trained people to determine the total behaviour of the foam on/in the hot beverage, as is common for determining the taste of products, is the most practicable method to determine total stability.

According to the invention, the composition comprises about 8-18% (w/w), preferably 10-16% (w/w), 11-15% (w/w), 12-14% (w/w), fat. The fat may be any fat known in the art. It may be from vegetable, animal or fish origin. As such, it may vary between the standard triglycerides derived from vegetable or animal source like coconut, palm kernel, palm, corn, cotton, olive, peanut, beef, fish, sheep, and so on, and can be hydrogenated or not. The type of fat selected will influence the taste and the fineness of the foam and by that the quality of the final product. Milk fat, preferably derived from fresh cream, is preferred according to the invention. The term “cream” as used herein has its normal meaning and refers to a dairy product that is composed of the higher-butterfat layer skimmed from the top of milk before homogenization. In unhomogenized milk, over time, the lighter fat rises to the top. In the industrial production of cream this process is accelerated by using centrifuges. In many countries, cream is sold in several grades depending on the total butterfat content. As used herein, the term “cream” comprises all such grades of cream. However, cream having a fat content of over 25% (w/w), preferably over 30% (w/w), even more preferably over 35% (w/w) is preferred. Alternatively, a blend of fats that together forms a mixture close to the composition of the triglycerides in milk fat is preferred. However, the invention is not limited to such fats.

According to the invention, the aerated composition comprises about 5-25 vol %, such as 8-25 vol. %, 10-22 vol. %, 12-21 vol. %, 15-19 vol. %, alcohol, based on the volume of the unaerated composition, i.e., based on the volume the composition would have if it had not been aerated. As such, the volume of the gas (overrun) is not included in the volume of the unaerated composition; however, the volume of all other components of the composition are included. The alcohol, which is preferably ethanol, may be any alcohol known in the art, but is preferably flavoured, and derived from a distillate. Suitable alcohol sources include, without limitation, whisky, rum, bourbon, Tia Maria, Grand Marnier, chocolate liqueur, brandy, Weinbrand, and the like. Using such alcohol sources, ready-to-go compositions may be prepared for preparing Irish Coffee (Irish whiskey), French Coffee (French brandy), Brazilian Coffee (Tia Maria—Grand Marnier), Spanish Coffee (Tia Maria—rum), Rudesheimer Kaffee (Weinbrand), and the like. The alcohol may also be added in the form of highly concentrated distillates, e.g., whiskey pre-distillates, at 60 to 80% alcohol.

The protein in the invention is present in the composition in an amount of 0.5-5% (w/w), such as 0.5-4% (w/w), 0.5-3% (w/w), 0.8-2.5% (w/w), 1-2% (w/w). The protein may be any protein, such as of vegetable origin, e.g., soy protein, pea protein, potato protein, rise protein, corn protein, of animal origin, e.g. egg protein, milk protein, and the like, or of fish origin. The protein preferably includes bovine protein. Said protein may advantageously include whole milk protein, whey protein, casein, or mixtures of two or more thereof. In an embodiment, said protein comprises at least gelatine, and preferably also milk protein. In another embodiment, said protein comprises at least milk protein, and preferably also gelatine. Said gelatin serves as a stabilizer, and aids in stabilizing the aerated composition of the present invention. In a preferred embodiment, said composition comprises gelatine in an amount of about 0.25-5% (w/w), such as about 0.35-4% (w/w), 0.45-3% (w/w), 0.55-2.5% (w/w), 0.7-2.2% (w/w), 0.9-2% (w/w). Such amounts are sufficient to stabilize the composition of the invention at an alcohol content up to 20 vol. %. At room temperature, an aerated composition obtained using 1% (w/w) gelatine may be stable for at least 8 weeks, preferably at least 12 weeks. The gelatine may be any type of gelatine known in the art. The gelatine may be acidic or alkaline gelatine. It may be derived from beef or pig, from hide or bones, or may be recombinant produced gelatine. The gelling power of gelatine is determined by the bloom-value. E.g., a similar gel strength may be obtained using 10 g gelatine having a bloom-strength of 200 or using 8 g gelatine having a bloom-strength of 250. One skilled in the art knows how to select the gelatine that is most suited to the present invention.

The composition further comprises water. The water content may vary depending on the concentration of other ingredients. The composition prior to aerating can contain up to 95% (w/w) of water, depending on the level of other ingredients added to the formulation. The water content can be 40-95% (w/w), preferably 60-95% (w/w) of water.

In an embodiment, the composition has an overrun of about 25% to about 55%, such as about 30% to about 50%, about 35% to about 45%. The gas included in the aerated composition of the invention can be any gas, but is preferably a food-grade gas such as air, nitrogen, or nitrous oxide (N₂O). In case the composition is prepared with the aid of an electric hand beater, such gas will most likely be air. However, when the composition is prepared using industrial equipment, e.g., an industrial aerator, it is preferred that the gas does not contain oxygen, e.g. N₂O or N₂ may be used.

In an embodiment, the composition further comprises sugar, such as about 10-25% (w/w), about 12-22% (w/w), or about 13-20% (w/w), sugar. The sugar may be added in order to sweeten the composition. As such, the sugar may be selected from any sugar known in the art, but preferably comprises sucrose. Other sugars that may be present include glucose, fructose, galactose, maltose and lactose. Alternatively, reduced-calorie and low-calorie sweeteners may be used. Such reduced-calorie sweeteners include sugar alcohols such as sorbitol, xylitol, maltitol, isomalt, lactitol, mannitol, erythritol, and hydrogenated starch hydrolysates, tagatose, trehalose, acesulfame potassium, aspartame, neotame, saccharin, sucralose, and the like. Combinations of any of the above are also possible. The skilled person is aware of methods determining the correct amounts of sugars and/or reduced-calorie and low-calorie sweeteners as applicable.

In an embodiment, fat-based emulsifiers, such as mono- or diglycerides or blends thereof of fatty acids, preferably of C16 and/or C18 acids (E 471), preferably in amounts of 0.1-0.25% (w/w) and/or esters of mono- and diglycerides (preferably C16 and/or C18 acids) with acetic acid or lactic acid (E 472), preferably in amounts of 0.3-0.5% (w/w) are used together with the fat. Examples of suitable fat-based emulsifiers include blends of mono- and diglycerides (e.g., Dimodan of Danisco Emulsifiers Denmark) and lactic acid esters of mono- and diglycerides (e.g., Grindsted Lactem from Danisco Emulsifiers Denmark) or acetic acid esters (e.g., Grindsted Acetem from Danisco Emulsifiers Denmark).

Also, one or more stabilizers may be added to the composition to facilitate preparation of the prefoam mix, and to increase stability of the final foam composition. Without stabilizer the foam composition may be stable for a limited time period and at a low temperature. Preferably the foam composition of the invention is stable for at least 8 weeks at room temperature; this is most convenient for the final user. However, for flavour reasons it is better to store the foam composition at refrigerator temperatures (i.e., at a temperature of 0-10° C., especially during transportation in summer season, when the foam needs to be stable against warming up in the back of a car. Suitable stabilizers include, without limitation, pectin (e.g, about 0.25-4% (w/w), such as about 0.5-2% (w/w), about 0.75-1.5% (w/w), about 1% (w/w)), cellulose such as microcrystalline cellulose and carboxylmethyl cellulose (e.g., together about 0.25-4% (w/w), such as about 0.5-2% (w/w), about 0.6-1.5% (w/w), about 0.7-1% (w/w), about 0.8% (w/w)), xanthan gum (e.g., about 0.025-0.5% (w/w), about 0.05-0.3% (w/w), about 0.075-0.15% (w/w), about 0.1% (w/w)) and gellan gum, and combinations of one or more thereof. It is to be noted that although gelatine may also be considered a stabilizer, according to the present invention, it is counted to be protein.

The composition according to the invention may have a pH ranging from 2.5-8.0, preferably 3.0-7.0, more preferably 3.5-6.5. In an embodiment, the composition has a pH ranging from 2.5-4.5, optionally 2.5-5.5, for application on acidic beverages, for example, grog or toddy (lemon juice with rum or whisky). In another embodiment, the composition has a pH from 5.5-8.0, preferably 6.5-8.0, more preferably 6.5-7.5, for application on, for example, coffee or chocolate milk.

In another aspect, the present invention relates to a method for preparing an aerated composition as defined herein, said method comprising the steps of: a) preparing a liquid phase comprising said fat, said protein, and said water, and optionally sugar, stabilizer, and further ingredients; b) aerating the liquid phase to obtain an aerated pre-composition; and c) mixing the aerated pre-composition with said alcohol to obtain said aerated composition.

For example, the composition of the invention may be prepared by adding the protein and cream to hot water, followed by cooling of the mixture and whipping thereof to incorporate air. Sugar, stabilizer and further food grade ingredients may be included. Subsequently, the alcohol may be blended in. Preferably, the alcohol is blended in during the last stages of the whipping process, e.g., when more than 30%, e.g., 40%, or 50%, of the final overrun to be achieved has been reached. Addition of alcohol reduces the final overrun.

Alternatively, particularly when solid fat is used rather than or in addition to cream, a premix may be prepared by mixing or homogenizing melted fat, optionally including fat-based emulsifiers as set forth below, with at least part of the protein, and optionally sugars as set forth below. This premix may subsequently be mixed with cream and sugar, and optionally another part of the protein, followed by heating to a temperature of about 40° C. to about 75° C. In case part of the protein is gelatine, it is preferred that the gelatine is first prehydrated in water, separately heated to a temperature of about 40° C. to about 75° C., and added to the premix-cream-sugar mixture. The resultant may subsequently be thoroughly mixed with a high speed blender or homogenizer, e.g., with a high pressure homogenizer at relatively low pressure like 100 bar.

The mixture prior to whipping, herein also referred to as “prefoam composition” or “prefoam mix”, may subsequently be whipped, e.g., using an electric hand beater, a kitchen blender or, preferably, an industrial aerator, using air or preferably, in case of using an industrial aerator, using non-oxygen gas like N₂ or N₂O, in such a way that small gas bubbles are formed. The overrun preferably is in the range of about 25% to about 55%. In a suitable embodiment, fat-based emulsifiers, such as mono- or diglycerides or blends thereof of fatty acids, preferably of C16 and/or C18 acids (E 471), and/or esters of mono- and diglycerides (preferably C16 and/or C18 acids) with acetic acid or lactic acid (E 472 a or b), are used, e.g. in amounts of about 0.1-0.25% (w/w) E471 and/or about 0.3-0.5% (w/w) E472. Such emulsifiers allow production of air bubbles with very small diameter, which improves the stability of the aerated product. One skilled in the art is capable of selecting the amount of fat-based emulsifier to suit this purpose. The suitable amount depends on various factors, including storage conditions of the product prior to aeration (temperature and time), the method and conditions of aeration, and the like. Generally, the skilled person will select the lowest amount of fat-based emulsifier still capable of producing and stabilizing small air bubbles.

Also, stabilizer may be added to the composition to facilitate preparation of the prefoam mix, and to increase stability of the final foam composition. Without stabilizer the foam composition may be stable for a limited time period and at a low temperature. Preferably the foam composition of the invention is stable for at least 8 weeks at room temperature; this is most convenient for the final user. However, for flavour reasons it is better to store the foam composition at refrigerator temperatures (i.e., at a temperature of 0-10° C., especially during transportation in summer season, when the foam needs to be stable against warming up in the back of a car. Suitable stabilizers include, without limitation, pectin (e.g, about 0.25-4% (w/w), such as about 0.5-2% (w/w), about 0.75-1.5% (w/w), about 1% (w/w)), cellulose such as microcrystalline cellulose and carboxymethyl cellulose (e.g., together about 0.25-4% (w/w), such as about 0.5-2% (w/w), about 0.6-1.5% (w/w), about 0.7-1% (w/w), about 0.8% (w/w)), xanthan gum (e.g., about 0.025-0.5% (w/w), about 0.05-0.3% (w/w), about 0.075-0.15% (w/w), about 0.1% (w/w)) and gellan gum, and combinations of one or more thereof. It is to be noted that although gelatine may also be considered a stabilizer, according to the present invention, it is counted to be protein.

With “suitable stabilizers” no differentiation is made between stabilizers and gelling agents nor thickeners. Purely scientifically, pectin could also be mentioned as a gelling agent and also others of the mentioned “suitable stabilizers” could have a double or triple function.

A preferred embodiment of the aerated composition of the invention which would be very suitable for preparing an Irish Coffee comprises about 15-19 vol. % alcohol derived from Irish Whiskey, about 8-14% (w/w) milk fat (optionally further comprising about 1-4% (w/w) other fat source), about 0.5-5% (w/w) protein including about 0.5-1.5% (w/w) gelatine, and has an overrun of about 30-50%. It may further comprise about 13-21% (w/w) sugar.

The composition according to the present invention is to be added to hot coffee, in such a way that an Irish Coffee is formed. Preferably, about 60 g of the composition of the invention is added to about 100 g of hot coffee. Most often a glass is used to serve Irish Coffee and the average final volume is approximately 200 ml.

It may be advantageous to package the composition of the invention in a single serve packaging, meaning one package of the composition of the invention is intended to create a single serving of the final hot beverage. The foam may then be packaged in such a way that it corresponds with the amount of coffee used. To increase convenience for the consumer, preferably a dedicated glass is used on which a marker is present to indicate the proper amount of hot coffee required to prepare a hot beverage comprising the composition of the invention. The size of the package will be such that it is sufficient for providing an Irish Coffee with an indicated amount of hot coffee. Preferably, about 100 g of hot coffee will be combined with about 60 g of the composition of the invention. Thus, said package may comprise about 40 to about 150 ml of the aerated composition of the invention. The single-serve packaging may be any type of packaging, such as a cup, or a squeezable container. The composition of the invention will then be added to the hot coffee by squeezing or spooning from the single serve package. If the amount of composition of the present invention is relatively higher, a stronger whiskey and alcohol note will be present, whereas with a lower dosage less cream and alcohol is added, such that the coffee flavour will be more pronounced. The composition of the present invention allows the consumer to tailor the strength of an alcoholic hot beverage, e.g., an Irish Coffee, to its own taste. The consumer may select the strength of the coffee used, as well as the amount of composition of the invention that is added, according to his own preference.

Package restrictions are standard restrictions like light, air and oxygen barrier, alcohol stability and the possibility of a clean and easy closure fitted to the filler used. The form of the package could be amongst others, a sealed cup, a sachet, a pouch, syringe and so on for the above mentioned single serve usage.

For catering, big kitchens, grand cafes, restaurants and so on, where relatively bigger volumes of alcoholic hot beverages, such as Irish Coffee, are being served, a dispenser system for the composition of the present invention could be used. In this case, a larger package form can be used, e.g., a bag-in-box system in combination with a pumping system to add the desired amount of composition of the invention to the coffee. It may also be possible to adjust bulk dispensing systems already in use in large restaurants.

In a further aspect, the present invention is concerned with the use of the aerated composition as defined herein for preparing an alcoholic hot beverage, as set forth above.

The present invention is herein exemplified by Irish Coffee. However, the present invention is not limited to compositions suitable for preparing Irish Coffee, as set forth hereinabove. Also, it is not required that the composition of the invention is used for preparing an alcoholic hot beverage. It may also be used for other purposes. For example, it may serve as an alcohol-comprising whipped cream for use on desserts, ice cream, cocktails, and the like.

(w/w), as herein used, is an abbreviation for “by weight,” used to describe the concentration of a substance in a mixture or solution. Herein, a weight percentage of 2, 2% (w/w), means that the mass of the substance is 2% of the total mass of the prefoam or aerated composition, i.e. the composition prior or subsequent to aeration.

Vol. % as used herein is an abbreviation for “by volume,” used to describe the concentration of a substance in a mixture or solution. Thus, 2 vol. % (also referred to as “2% (v/v)”) means that the volume of the substance is 2% of the total volume of the prefoam composition, i.e., prior to aeration, plus the volume of the alcohol, which may be added after aeration. E.g., assuming about 575 ml prefoam composition is aerated and subsequently blended with 425 ml Irish whiskey (comprising 40 vol. % alcohol) yields an alcohol content in the total aerated product of 17 vol. %.

In this document and in its claims, the verb “to comprise” and its conjugations is used in its non-limiting sense to mean that items following the word are included, but items not specifically mentioned are not excluded. In addition, the verb “to consist” may be replaced by “to consist essentially of” meaning that a composition of the invention may comprise additional component(s) than the ones specifically identified, said additional component(s) not altering the unique characteristics of the invention.

The word “approximately” or “about” when used in association with a numerical value (approximately 10, about 10) preferably means that the value may be the given value of 10 plus or minus 1% of the value. In addition, reference to an element by the indefinite article “a” or “an” does not exclude the possibility that more than one of the element is present, unless the context clearly requires that there be one and only one of the elements. The indefinite article “a” or “an” thus usually means “at least one”.

All patent and literature references cited in the present specification are hereby incorporated by reference in their entirety.

It will be clear that the above description and drawings are included to illustrate some embodiments of the invention, and not to limit the scope of protection. Starting from this disclosure, many more embodiments will be evident to a skilled person which are within the scope of protection and the essence of this invention and which are obvious combinations of prior art techniques and the disclosure of this patent.

### EXAMPLES

### Example 1

### Prefoam Preparation for Irish Coffee

Preparation of a Prefoam-Mix

50 g water was added to 20 g gelatine and left for 15 minutes to pre-hydrate.

175 g sucrose was dissolved into 437 g high fat cream (35% fat). This mixture was preheated at 72° C. The gelatine solution prepared above was heated to 72° C. and was subsequently blended into the cream-sugar mix. The resultant was blended thoroughly with a high speed blender, and was then cooled to at least 15° C. and stored for at least 15 minutes and for one night at 4° C.

Alcoholic Foam Preparation

The prefoam mix was whipped with an electric hand beater. The amount of overrun was 0% after a storage of 15 minutes.

The cream stored for one night at 4° C. was whipped to an overrun of 70%. This overrun is lower than standard (approx. 100%) when cream is whipped for decoration like on desserts and cakes, to keep it more fluent—liquid. Alcohol addition to a liquid foam is easier than to a cream whipped to a heavy consistency.

Next, 575 ml foam (volume prior to whipping of the prefoam) was blended with 425 ml Jameson Irish Whiskey (40 vol. % alcohol) in order to yield a homogeneous foam having an overrun of about 40%. This whipped prefoam was somewhat sensitive to the blending of alcohol: the foam had a tendency to break down and form larger air bubbles, when the addition of alcohol was done too fast or at the wrong moment in the whipping process (too early or when a too heavy consistency was achieved). The foam was filled into a final packaging and cooled to refrigerator temperature.

Preparation of Irish Coffee

60 g of this foam was carefully poured on 100 g hot coffee in a typical Irish Coffee glass. The Prefoam resulted in an Irish Coffee with a beautiful smell of Irish Whiskey, cream and coffee. The taste of this Irish Coffee was fully comparable with a traditionally prepared Irish Coffee, using the same coffee and Irish Whiskey.

When the blending with the alcohol was not exactly done in the above mentioned right way, the foam with more coarse air bubbles showed a (too) fast melting of the foam and the foam layer was less nice than of above mentioned result. The packages with fine air bubbles behaved even better on the hot coffee, compared to the traditional prepared Irish Coffee: the foam stayed for a longer time. An untouched glass still had approx. 20% of the volume of the original foam layer after half an hour and as such resembled a traditionally prepared Irish Coffee.

### Example 2

Prefoam Preparation for Irish Coffee

Preparation of a Foam-Stabiliser Mix

3.0 g sodium caseinate and 21 g glucose syrup (100%=glucose syrup solids) were dissolved in hot water. Di sodium phosphate was added to compensate for the hardness of the water. 18.8 g hydrogenated coconut fat and 5.9 g fat-based emulsifiers (a blend of 1 g of mono- and diglycerides (Dimodan of Danisco Emulsifiers Denmark) and 4.9 g of esters of mono- and diglycerides with lactic acid (Grindsted Lactem of Danisco Emulsifiers Denmark) were melted and blended carefully without air incorporation. When fully dissolved into each other this fat phase was added to the caseinate-glucose syrup solution and this was homogenised with a high pressure homogeniser.

Preparation of a Prefoam Mix

50 g water was added to 10 g gelatine and left for 15 minutes to pre-hydrate.

175 g sucrose was dissolved into 262 g high fat cream (42% fat) and the foam-stabiliser mix was added. This mixture was preheated at 72° C. The gelatine solution prepared above was heated to 72° C. and was subsequently blended into the cream-foam-stabiliser mix. The resultant was blended thoroughly with a high speed blender, and was then cooled to at least 15° C. and stored for at least 15 minutes.

Alcoholic Foam Preparation

The prefoam mix was whipped with an electric hand beater. The amount of overrun was 80%.

Next, 575 ml foam (volume prior to whipping of the prefoam) was blended with 425 ml Irish Whiskey (40 vol. % alcohol) (Jameson Irish Whiskey) in order to yield a homogeneous foam having an overrun of about 40%. The foam was filled into a final packaging and cooled to refrigerator temperature.

Compared to Example 1 this foam was much easier to prepare to a soft, semi liquid whipped cream that was much easier to blend with the alcohol, without resulting in a foam with coarse air bubbles.

Preparation of Irish Coffee

60 g of this foam was carefully poured on 100 g hot coffee in a typical Irish Coffee glass. The foam slowly melted and made a slow penetration of cream into the coffee, causing a slow change in colour from black to gold brown. The foam was half melted after 20 minutes giving a beautiful smell of Irish whiskey and coffee, with a hint of cream. The taste of this Irish Coffee was fully comparable with a traditionally prepared Irish Coffee, using the same coffee and Irish Whiskey.

This example not only shows the advantage compared to traditionally prepared Irish Coffee by convenience in use, but also that it is more easy by one person to produce several glasses of Irish Coffee with equally nice visual look.

An untouched glass still had approx. 20% of the volume of the original foam layer after half an hour and as such resembled a traditionally prepared Irish Coffee.

### Example 3

### Preparation of Irish Coffee

Preparation of a Foam-Stabiliser Mix

3.0 g sodium caseinate and 21 g glucose syrup solids were dissolved in hot water. Di sodium phosphate was added to compensate for the hardness of the water. 18.8 g palm oil and 5.9 g fat-based emulsifiers (a blend of 1 g of mono- and diglycerides (like Dimodan of Danisco Emulsifiers Denmark and 4.9 g of esters of mono- and diglycerides with acetic acid (like Grindsted Acetem of Danisco Emulsifiers Denmark) were melted and blended carefully without air incorporation. When fully dissolved into each other this fat phase was added to the caseinate-glucose syrup solution (similar as prepared in Example 2) and this was homogenised with a high pressure homogeniser.

Preparation of a Prefoam Mix

50 g water was added to 10 g gelatine and left for 15 minutes to pre-hydrate.

175 g sucrose was dissolved into 262 g high fat cream (42% fat) and the foam-stabiliser mix was added. This mixture was preheated at 72° C. The gelatine solution prepared above was heated to 72° C. and was subsequently blended into the foam-stabiliser mix. The resultant was blended thoroughly with a high speed blender, and was then cooled to at least 15° C. and stored for at least 15 minutes.

Alcoholic Foam Preparation

The prefoam mix was whipped with an electric hand beater. The amount of overrun was 80%.

Next, 575 ml foam (volume prior to whipping of the prefoam) was blended with 425 ml Irish Whiskey (40 vol. % alcohol) in order to yield a homogeneous foam having an overrun of about 40%. The foam was filled into a final packaging and cooled to refrigerator temperature.

Irish Coffee was prepared as described in Example 1. The performance of the foam on the hot coffee was equal to example 2.

### Example 4

Preparation of a Foam-Stabiliser Mix

3.0 g sodium caseinate and 21 g glucose syrup solids were dissolved in hot water. Di sodium phosphate was added to compensate for the hardness of the water. 18.8 g hydrogenated palmkernell oil and 5.9 g fat-based emulsifiers (a blend of 1 g of mono- and diglycerides (Dimodan of Danisco Emulsifiers, Denmark) and 4.9 g of esters of mono- and diglycerides with lactic acid (Grindsted Lactem of Danisco Emulsifiers, Denmark)) were melted and blended carefully without air incorporation. When fully dissolved into each other this fat phase was added to a caseinate-glucose syrup solution (similar as prepared in Example 2) and this was homogenised with a high pressure homogeniser.

Preparation of a Prefoam Mix

50 g water was added to 10 g gelatine and left for 15 minutes to pre-hydrate.

175 g sucrose was dissolved into 262 g high fat cream (42% fat) and the foam-stabiliser mix was added. This mixture was preheated at 72° C. The gelatine solution prepared above was heated to 72° C. and was subsequently blended into the cream-foam-stabiliser mix. The resultant was blended thoroughly with a high speed blender, and was then cooled to at least 15° C. and stored for at least 15 minutes.

Alcoholic Foam Preparation

The prefoam mix was whipped with an industrial whipper (Mondomix 50). The amount of overrun was set to 75%.

Next, 575 ml foam (volume prior to whipping of the prefoam) was blended with 425 ml Asbach Uralt (38 vol. % alcohol) in order to yield a homogeneous foam having an overrun of about 45%. The foam was filled into a final packaging and cooled to refrigerator temperature.

Preparation of Rudesheimer Kaffee

60 g of the alcoholic foam was added on top of 100 g hot coffee in a glass. The foam slowly melted and made a slow penetration of cream into the coffee, causing a slow change in colour from black to gold brown. The foam was half melted after 20 minutes. The performance of the foam on the hot coffee was comparable to example 2. The taste of the Rudesheimer Kaffee thus prepared was identical to Rudesheimer Kaffee prepared in a traditional way.

### Example 5

### Prefoam Preparation for Irish Coffee

Preparation of a Foam-Stabiliser Mix

3.0 g sodium caseinate and 21 g glucose syrup solids were dissolved in hot water. Di sodium phosphate was added to compensate for the hardness of the water. 18.8 g hydrogenated palm kernel oil and 5.9 g fat-based emulsifiers (a blend of 1 g of mono- and diglycerides (Dimodan of Danisco Emulsifiers Denmark) and 4.9 g of esters of mono- and diglycerides with acetic acid (Grindsted Acetem of Danisco Emulsifiers Denmark) were melted and blended carefully without air incorporation. When fully dissolved into each other this fat phase was added to the caseinate-glucose syrup solution and this was homogenised with a high pressure homogeniser.

Preparation of a Prefoam Mix

50 g water was added to 10 g gelatine and left for 15 minutes to pre-hydrate.

175 g sucrose was dissolved into 262 g high fat cream (42% fat) and the foam-stabiliser mix was added. This mixture was preheated at 72° C. The gelatine solution prepared above was heated to 72° C. and was subsequently blended into the cream-foam-stabiliser mix. The resultant was blended thoroughly with a high speed blender, and was then cooled to at least 15° C. and stored for at least 15 minutes.

Alcoholic Foam Preparation

The prefoam mix was whipped with an electric hand beater. The amount of overrun was 80%.

Next, 575 ml foam (volume prior to whipping of the prefoam) was blended with 425 ml Irish Whiskey (40 vol. % alcohol) (Jameson Irish Whiskey) in order to yield a homogeneous foam having an overrun of about 40%. The foam was filled into a final packaging and cooled to refrigerator temperature.

Preparation of Irish Coffee

60 g of this foam was poured on 100 g hot coffee in a typical Irish Coffee glass. The Irish Coffee characteristics were comparable to Example 2.

1-14. (canceled)

15. An aerated composition comprising about 5-25 vol % alcohol, based on the total volume of the composition prior to aeration, about 8-18% (w/w) fat, about 0.5-5% (w/w) protein, said protein comprising gelatin, and water, said aerated composition having an overrun of at least about 10%.

16. The aerated composition of claim 15, further comprising sugar.

17. The aerated composition of claim 15, further comprising one or more fat-based emulsifiers.

18. The aerated composition of claim 15, which exhibits an overrun of at least about 25%.

19. The aerated composition of claim 15, which is stable for at least 8 weeks at a temperature of 0-10° C.

20. The aerated composition of claim 15, in which the protein comprises about 0.25-2% (w/w) gelatin.

21. The aerated composition of claim 15, which further comprises a stabilizer.

22. The aerated composition of claim 21, in which said stabilizer is selected from the group consisting of pectin, cellulose such as microcrystalline cellulose and carboxymethyl cellulose, xanthan gum and gellan gum, and combinations of one or more thereof.

23. A single-serve package comprising an aerated composition of claim 15.

24. The single-serve package of claim 23, said package comprising about 40 to about 150 ml of said aerated composition.

25. A method for the preparation of an aerated composition comprising the steps of:
a) Preparing a liquid phase comprising fat, protein, and water, and optionally sugar, stabilizer, and other ingredients;
b) Aerating the liquid phase to obtain an aerated pre-composition; and
c) Mixing the aerated pre-composition with alcohol to obtain an aerated composition.

26. The method of claim 25, in which said liquid phase comprises cream.

27. The method of claim 25, in which said liquid phase comprises gelatin.

28. An alcoholic hot beverage, which is prepared from an aerated composition comprising about 5-25 vol % alcohol, based on the total volume of the composition prior to aeration, about 8-18% (w/w) fat, about 0.5-5 (w/w) protein, said protein comprising gelatin, and water, said aerated composition having an overrun of at least about 10%.
